(19) United States
(12) Patent Application Publication
(10) Pub. No.: US 2004/0149375 A1
(43) Pub. Date: Aug. 5, 2004

(54) Method for encapsulating a secondary battery

(76) Inventors: Shun-Ming Huang, Taipei (TW); Chih-Chang Lee, Hsinchu (TW); Mei-Hui Wang, Hsinchu (TW); Chih-Ming Chen, Taipei (TW)

Correspondence Address: Harold V. Stotland, 42nd Floor, 55 East Monroe Street, Chicago, IL, 60603-5803, US

(21) Appl. No.: 10/358,648

(22) Filed: Feb. 5, 2003

(51) Int. Cl. B32B 31/00

(52) U.S. Cl. 156/213; 156/307.5

(57) ABSTRACT

The present invention provides a method for encapsulating a secondary battery. The method first impregnates a fiber fabric with a resin composition, and then a first heating process is performed to form an adhesive sheet. A jelly-roll of a battery is encapsulated with the adhesive sheet, and then a second heating process is performed to cure the adhesive sheet completely. The first heating process initiates a preliminary reaction to transform the resin composition into a B state to form an adhesive sheet, and the adhesive sheet in the B state is convenient to be further processed or stored. Since the adhesive sheet in the B state possesses a property capable of further curing, the adhesive sheet can be processed into any shape when a further curing process is performed. Therefore, the battery can be easily manufactured with a curved, wound or any arbitrary shape, and the thickness of the battery will not be increased obviously. As a result, the present invention really achieves the object to make the battery light, slim, short and small. Additionally, the present invention also provides a new secondary battery encapsulated with fiber reinforced plastic.

### BACKGROUND OF THE INVENTION

1. Field of the Invention

The present invention relates to a secondary battery, and more particularly, to a method for encapsulating a secondary battery and a secondary battery manufactured thereby.

2. Background of the Invention

In recent years, portable electronics such as mobile phones, notebooks, personal digital assistants, digital cameras and so forth, are widely expanded and required to be light, slim, short and small. The size and weight of each element of the portable electronics are strictly limited to meet the requirement wherein the power supply, that is, a secondary battery, influences the weight and shape of the portable electronics in the majority.

In order to meet the requirement, the secondary battery is strictly limited on volume and weight. The shape is no longer limited on being rectangular and flat, but tends to become curved and wound so that the shape can be arbitrarily changed to fit any kind of space provided by a portable electronics.

According to the prior art method for manufacturing a secondary battery, a conductive article is first coated separately with positive active material and negative active material to form positive and negative electrodes. A separating film is then used to separate the positive and negative electrodes to form a jelly-roll, and the jelly-roll is subsequently encapsulated to complete a secondary battery. The prior art secondary battery is encapsulated in a metallic container to clad the jelly-roll completely. However, since the metallic container is thick, heavy, difficult in sealing, and only able to be processed into a rectangular shape, there is poor variation with the secondary battery encapsulated in a metallic container. Even if the thickness of the metallic container is reduced from 8 mm to 4 mm, it still has difficulty meeting the requirement of being light, slim, short and small.

Instead of the metallic container, aluminum foil laminating is used to encapsulate the jelly-roll of the secondary battery. However, since the jelly-roll of the secondary battery has very low mechanical strength, it is not easy to set the jelly-roll by using aluminum foil laminating to encapsulate the jelly-roll. It is particularly difficult for a battery with a curved or wound shape.

There are many improved methods for aluminum foil laminating, and a thin-film coating method and an injection-solution reaction method are two of these methods commonly used in the secondary battery industry. The thin-film coating method coats an adhesive-gel layer on electrodes or on separating film, and a thermal rolling process is then performed to encapsulate the jelly-roll with the aluminum foil. Although thin-film coating method can closely encapsulate the jelly-roll of the secondary battery, there are still many shortages such as difficulty in processing and lacking of mature adhesive-gel. The injection-solution reaction method, another improved method for aluminum foil laminating, injects solution consisting of monomer and electrolyte into an aluminum foil bag, and a thermal process is then performed to polymerize the monomer to set the secondary battery. Although the injection-solution reaction method is simpler, it is not easy to control the processing temperature, processing duration and degree of polymerization and may cause non-uniform electrical properties. Particularly, the injection-solution reaction method can't be applied to the plastic lithium-ion battery, Bellcore battery, which is now aggressively improved.

In order to meet the requirement of being light, slim, short and small, the curved secondary battery is what is most popularly developed for the future market. The present invention uses a processing method for Fiber Reinforced Plastic (FRP) to develop a method for manufacturing a secondary battery capable of setting and curving to provide a new and effective method for encapsulating a secondary battery, and a secondary battery manufactured thereby.

### SUMMARY OF THE INVENTION

The first object of the present invention is to provide a method for encapsulating a secondary battery that can quickly manufacture a battery with curved, wound or arbitrary shape so that the shape of the secondary battery can be changed to fit any kind of space provided by portable electronics.

The second object of the present invention is to provide a method for encapsulating a secondary battery that can closely and uniformly encapsulate the jelly-roll of the secondary battery so that the electric properties of the secondary battery is secured and the cycle number of the secondary battery is dramatically improved.

The third object of the present invention is to provide a method for encapsulating a secondary battery that can dramatically reduce the weight, thickness and volume of the secondary battery so that the cost for encapsulating the secondary battery is therefore tremendously reduced.

The fourth object of the present invention is to provide a method for encapsulating a secondary battery that includes simple processing steps and uses common encapsulating material so that the cost for encapsulating the secondary battery is therefore tremendously reduced.

The fifth object of the present invention is to provide a method for encapsulating a secondary battery that can change the shape of the secondary battery to fit any space provided by the portable electronics, and without increasing the thickness obviously.

In order to achieve the above-mentioned object and avoid the problems of the prior art, the present invention provides a method for encapsulating the secondary battery. The present invention method comprises the following steps:

(a) impregnating a fiber fabric with a resin composition, and then performing a first heating process to form an adhesive sheet; and

(b) encapsulating a jelly-roll of a battery with the adhesive sheet, and then performing a second heating process to cure the adhesive sheet.

### BRIEF DESCRIPTION OF THE DRAWINGS

Other objects and advantages of the present invention will become apparent upon reading the following description and upon reference to the accompanying drawings in which:

FIG. 1 is a schematic diagram of the preferred embodiment of encapsulating the jelly-roll of the secondary battery according to the present invention.

FIG. 2a is a comparative diagram showing the electrical properties under different discharging current of model number 603048 standard lithium-ion battery encapsulated according to the prior art.

FIG. 2b illustrates a comparative diagram showing the electrical properties under different discharging current of the model number 603048 standard lithium-ion battery encapsulated according to the present invention.

FIG. 2c illustrates a comparative diagram showing the electrical properties under different temperature of the model number 603048 standard lithium-ion battery encapsulated according to the prior art.

FIG. 2d illustrates a comparative diagram showing the electrical properties under different temperature of the model number 603048 standard lithium-ion battery encapsulated according to the present invention.

FIG. 2e illustrates a comparative diagram showing the cycle number of model number 603048 standard lithium-ion battery encapsulated according to the prior art and according to the present invention, wherein curve (a) represents the cycle number of the lithium-ion battery encapsulated according to the prior art, and curve (b) represents the cycle number of the lithium-ion battery encapsulated according to the present invention.

### PREFERRED EMBODIMENT OF THE PRESENT INVENTION

The disclosed method for encapsulating a secondary battery closely encapsulates a jelly-roll of the secondary battery according to the disclosed processes of the present invention, and the jelly-roll and the encapsulating material are prepared separately wherein the jelly-roll is prepared according to the prior art.

According to the present invention method, a fiber fabric is previously impregnated with a resin composition and completely wet by the resin composition. A first heating process is performed to initiate a preliminary reaction to transform the resin composition into a B state to form an adhesive sheet. The first heating process is performed at a temperature range between room temperature and 140° C., and is preferably performed at a temperature range between 80° C. and 120° C. The first heating process is performed in a range of 1 to 180 minutes, and is preferably performed in a range of 1 to 10 minutes.

The present invention uses the fiber fabric as a reinforcing material for an encapsulating material, and the reinforcing material can be any fiber fabric used as reinforcing material according to the prior art. For example, the fiber fabric can be selected from the group consisting of glass fiber fabric, carbon fiber fabric, Kevlar fiber fabric, PP fiber fabric and mixture thereof, and the glass fiber fabric is preferred. The resin composition used in the present invention comprises resin, curing agent, plasticizer, initiator and filler. The present invention uses a resin that is any thermal setting resin used according to the prior art, and for example, can be selected from the group consisting of epoxy resin, polyurethane, unsaturated polyester resin, interpenetrating polymer network (IPN) resin and mixture thereof, and the epoxy resin and the IPN resin are preferred. The present invention uses a curing agent such as amine, acid anhydride, and carboxylic acid. For example, the curing agent can be selected from the group consisting of diethyltriamine, triethyltetramine, diethyl-4-methylimidazole, Dicyandiamide, polyaminde, maleic Anhydride, hexahydrogenbutylbenzene dianhydride (HHPA) and mixture thereof, and the diethyl-4-methylimidazole is preferred. The filler is used to increase mechanical strength and can be selected from the group consisting of silicon dioxide, aluminum oxide, calcium carbonate, titanium oxide and mixture thereof, and the silicon dioxide is preferred.

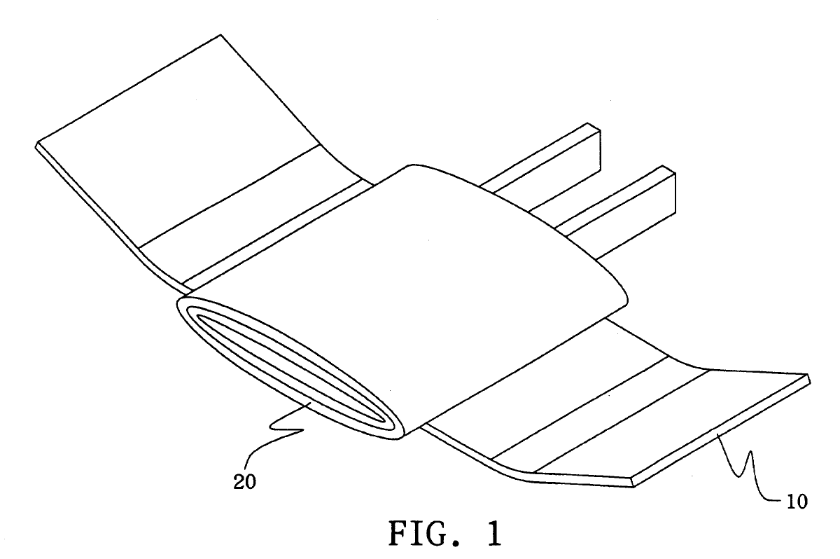

According to the present invention method for encapsulating the secondary battery, the first heating process will initiate a preliminary reaction to transform the resin into a B state to form an adhesive sheet, and the adhesive sheet 10 is then used to clad the jelly-roll 20 of the secondary battery, as shown in FIG. 1. A second heating process is performed to cure the adhesive sheet completely by using the characteristics of further curing the adhesive sheet 10. Since the adhesive sheet 10 in the B state possesses a further curable property, the adhesive sheet 10 can be processed into any shape when a further curing process, such as a second heating process, is performed. Therefore, the battery can be easily manufactured with a curved, wound or any arbitrary shape, and the thickness of the battery will not be increased obviously. As a result, the present invention really achieves the object to make the battery light, slim, short and small. The second heating process is performed at a temperature range between room temperature and 140° C., and a temperature range between 80° C. and 120° C. is preferred. The second heating process is performed in a range of 30 minutes and 24 hours, and the range of 30 minutes to 3 hours is preferred. Moreover, the completely cured adhesive sheet of the present invention does not adsorb electrolyte of the battery and is not discomposed due to the charging/discharging reaction to influence the electrical properties of the battery, and possesses excellent mechanical properties and stabilities, etc. Therefore, the present invention discloses a method for encapsulating a battery on a condition that the electrical properties are not influenced, the cycle number is dramatically increased, the thickness is thinner than the prior art rectangular battery, and the shape can be designed arbitrarily.

The present invention method for encapsulating a battery can be applied to the prior art secondary battery such as nickel-hydrogen secondary battery, lithium-ion battery and lithium polymer battery, and the lithium-ion battery and the lithium polymer battery are preferred.

According to the preferred embodiment of the present invention, a glass fiber fabric is impregnated with an epoxy resin composition, and a first heating process is performed. The first heating process is performed in a thermal rolling machine so that a thermal rolling process is also performed during the first heating process. As a result, the formed adhesive sheet will possess a more uniform thickness in a range of 60 to 200 μm, and the range of 80 to 140 μm is preferred. After the glass fiber fabric is impregnated with the epoxy resin composition, sticky sheets can be adhered to both the top and the bottom sides of the glass fiber fabric, and another first heating process is further performed to form an adhesive sheet capable of being mechanically wound to a batch. The wound adhesive sheet is convenient for storage and can be cut into bands for usage, and the sticky sheet is, for example, formed of polyethylenetelephthalate (PET).

The cut adhesive sheet is used to encapsulate the jelly-roll of a battery by automatic machine or by hand, and then a second heating process is performed to cure the resin in the adhesive sheet completely. The second heating process can be performed in a mold so that the battery can be formed with a curved, wound, or any arbitrary shape.

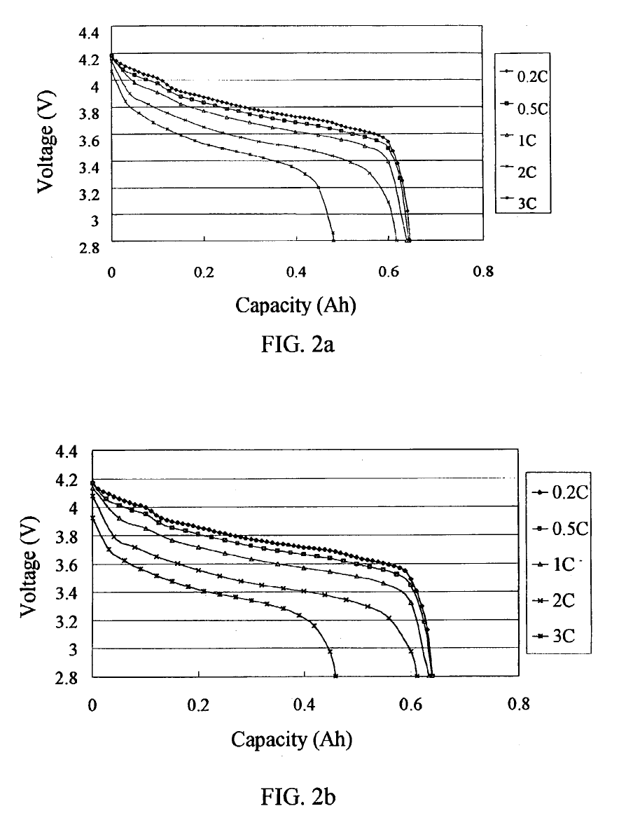

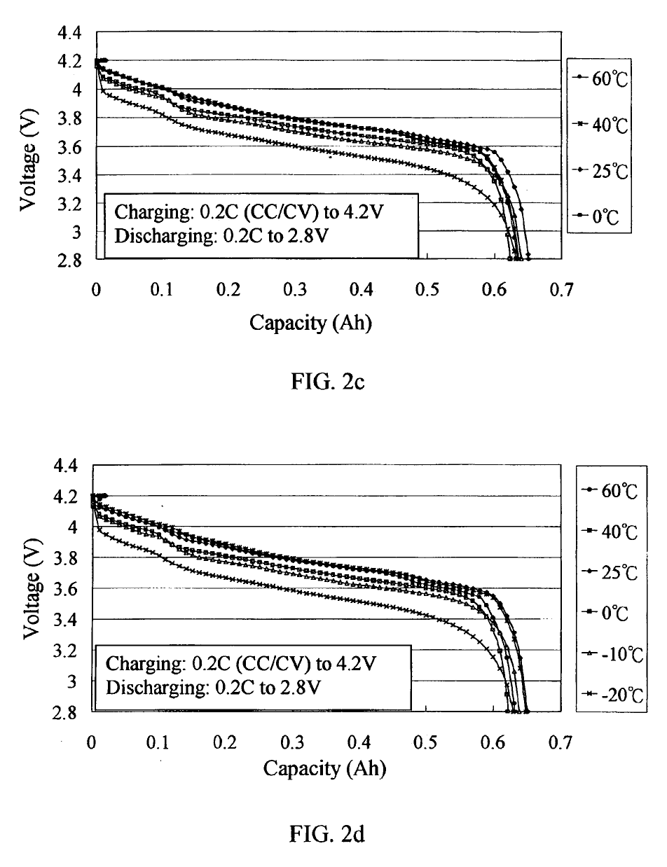

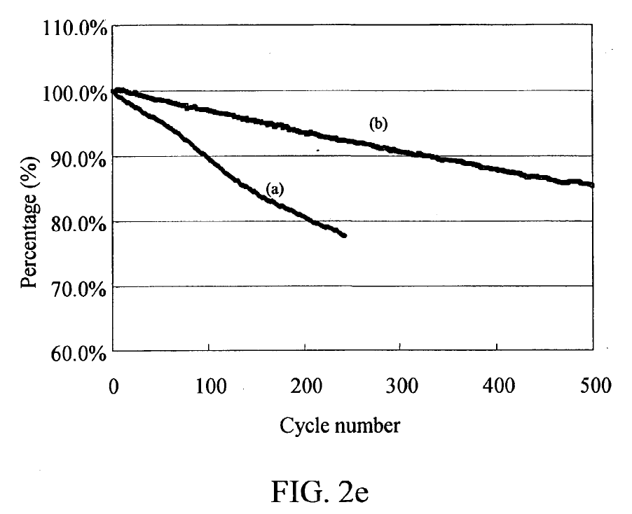

FIG. 2a to FIG. 2d illustrate comparative diagrams showing the electrical properties under different discharging current and under different temperature of the model number 603048 standard lithium-ion battery encapsulated according to the prior art and according to the present invention. Referring to these diagrams, the discharging efficiency of the battery encapsulated according to the present invention, under different discharging current and under different temperature, is effectively maintained.

FIG. 2e illustrates a comparative diagram showing the cycle number of model number 603048 standard lithium-ion battery encapsulated according to the prior art and according to the present invention, wherein curve (a) represents the cycle number of the lithium-ion battery encapsulated according to the prior art, and curve (b) represents the cycle number of the lithium-ion battery encapsulated according to the present invention. Referring to FIG. 2e, the cycle number of the battery encapsulated according to the present invention, at a condition of maintaining 80% electrical capacity, is increased up to 600 times, comparative to 200 times of the prior art.

The above-described embodiments of the present invention are intended to be illustrative only. Numerous alternative embodiments may be devised by those skilled in the art without departing from the scope of the following claims.

What is claimed is:

1. A method for encapsulating a secondary battery, comprising the steps of:
impregnating a fiber fabric with a resin composition;
performing a first heating process to form an adhesive sheet;
encapsulating a jelly-roll of the battery with the adhesive sheet; and
performing a second heating process to cure the adhesive sheet.

2. The method for encapsulating a secondary battery of claim 1, wherein the fiber fabric is selected from the group consisting of glass fiber fabric, carbon fiber fabric, Kevlar fiber fabric, PP fiber fabric and mixture thereof.

3. The method for encapsulating a secondary battery of claim 2, wherein the fiber fabric is glass fiber fabric.

4. The method for encapsulating a secondary battery of claim 1, wherein the resin composition comprises resin, curing agent, plasticizer, initiator and filler.

5. The method for encapsulating a secondary battery of claim 4, wherein the resin is a thermal setting resin.

6. The method for encapsulating a secondary battery of claim 4, wherein the resin is selected from the group consisting of epoxy resin, polyurethane, unsaturated polyester resin, interpenetrating polymer network resin and mixture thereof.

7. The method for encapsulating a secondary battery of claim 6, wherein the resin is epoxy resin.

8. The method for encapsulating a secondary battery of claim 4, the filler is selected from the group consisting of silicon dioxide, aluminum oxide, calcium carbonate, titanium oxide and mixture thereof.

9. The method for encapsulating a secondary battery of claim 8, wherein the filler is silicon dioxide.

10. The method for encapsulating a secondary battery of claim 1, wherein the first heating process is performed in a range of room temperature to 140° C.

11. The method for encapsulating a secondary battery of claim 1, wherein the first heating process is preferably performed in a range of 80° C. to 140° C.

12. The method for encapsulating a secondary battery of claim 1, wherein the first heating process is performed in a range of 1 to 180 minutes.

13. The method for encapsulating a secondary battery of claim 1, wherein the first heating process is preferably performed in a range of 1 to 10 minutes.

14. The method for encapsulating a secondary battery of claim 1, further comprising a step of performing a thermal rolling process.

15. The method for encapsulating a secondary battery of claim 1, wherein the adhesive sheet has a thickness in a range of 60 to 200 μm.

16. The method for encapsulating a secondary battery of claim 15, wherein the adhesive sheet preferably has a thickness in a range of 80 to 140 μm.

17. The method for encapsulating a secondary battery of claim 1, wherein the second heating process is performed in a mold.

18. The method for encapsulating- a secondary battery of claim 1, the second heating process is performed in a range of room temperature to 140° C.

19. The method for encapsulating a secondary battery of claim 18, wherein the second heating process is preferably performed in a range of 80 to 120° C.

20. The method for encapsulating a secondary battery of claim 1, wherein the second heating process is performed in a range of 30 minutes to 24 hours.

21. The method for encapsulating a secondary battery of claim 1, wherein the second heating process is preferably performed in a range of 30 minutes to 3 hours.
